(19) United States
(12) Patent Application Publication
(10) Pub. No.: US 2026/0201890 A1
(43) Pub. Date: Jul. 16, 2026

(54) Modular Pump System

(71) Applicant: Dajustco IP Holdings Inc., Coquitlam (CA)

(72) Inventors: Peter Francis Van-de-Velde, Coquitlam (CA); Nicholas James Guenther, Coquitlam (CA); Bhargav Parshottambhai Vora, Coquitlam (CA)

(73) Assignee: Dajustco IP Holdings Inc., Coquitlam, BC (CA)

(21) Appl. No.: 19/142,138

(22) PCT Filed: Dec. 22, 2023
(86) PCT No.: PCT/CA2023/051762

§ 371 Date: Jun. 20, 2025

Related U.S. Application Data
(60) Provisional application No. 63/477,037, filed on Dec. 23, 2022.

(30) Foreign Application Priority Data
Dec. 23, 2022 (CA) 3184913

(51) Int. Cl. F04D 13/14; F04D 1/00; F04D 29/42; F04D 29/58

(52) U.S. Cl. CPC F04D 13/14; F04D 1/00; F04D 29/426; F04D 29/5806

(57) ABSTRACT

A modular pump system for pumping a pumping media includes a plurality of identical, releasably interconnecting pumps. Each pump has a housing with an inlet at a first end and an outlet at a second, opposite end of the housing, a suction at the inlet and a discharge at the outlet. Each pump includes an impeller downstream of the suction, the impeller mounted to a shaft, the shaft rotatable by a motor, the motor, shaft and impeller enclosed within the housing. The discharge of a first pump is directly connectable to the suction of a second pump. The pump housing has a cuboid geometry, which may be a rectangular prism, allowing for the efficient stacking, installation, transport and storage of the pumps. The pumps may be connected in parallel and/or in series, and the pumps may be submersible pumps with dry run capability.

### CROSS-REFERENCE TO RELATED APPLICATIONS

This application claims the benefit of U.S. Provisional Application No. 63/477,037 and Canadian Patent Application No. 3,184,913, both filed on Dec. 23, 2022 and both entitled “Modular Pump System”, both of which are incorporated herein by reference.

### TECHNICAL FIELD

The present disclosure relates to modular pump systems; in particular, the disclosure relates to modular pump systems comprising of pumps which may be directly mounted or otherwise connected, in series and/or in parallel, to one another.

### BACKGROUND

Centrifugal pumps of various types are known in the prior art and are available in a large horsepower (HP) range; for example, individual pumps may have a horsepower rating in the range of 1 HP to 1000 HP. To achieve a desired pumping pressure, or head, and flow rate for an application, a pump manufacturer may provide, for example, dozens or hundreds of pumps of different configurations. The different pump configurations may have different horsepower ratings, and discharge and/or impeller sizes. A performance curve chart may typically be used to select a particular pump configuration that provides the desired head and flow rate for a given application. Examples of performance curve charts, for conventional pumps, are provided at FIGS. 1A to 1C. For example, with reference to FIG. 1A, an application requiring a head of 300 feet and a flow rate of 300 gallons per minute (gpm) may utilize a model DBH 100/75 HH pump, while a second application requiring a head of 100 feet and a flow rate of 3000 gpm may utilize a model DBH 200/150 LH pump. The different configurations of conventional pumps may, for example, be configured with different wet ends and impellers, designed for different pumping applications, such as: handling water or aqueous solutions, handling slurries or viscous fluids, handling slurries with varying sizes of solids present in the slurry, handling corrosive fluids or fluids with different chemical properties, handling water with large debris, etc. Each type of application may require a particular configuration of pump; in some cases, more than one pump may be required, with such pumps connected to each other in series or parallel, to provide the required head and flow rate.

A user of pumps may therefore conventionally stock an inventory of pumps, having a range of horsepower ratings, wet end configurations, impellers, and so forth to suit a variety of applications at the site. Each pump configuration would typically have a fixed horsepower rating. In addition, the inventory may also include different types of pumps for different applications; for example, a typical pump inventory may include multi-stage pumps, submersible pumps, cantilevered pumps and horizontal pumps, allowing for different pumping configurations depending on space and clearance considerations, as well as the characteristics of the pumping media to be pumped.

Using a mining operation as an example, without intending to be limiting, an illustration of the different types of pumps that may be required is as follows. Multi-stage pumps, consisting of a plurality of impellers and casings connected together in a vertical stack and driven by single shaft, may be used to dewater a portion of the mine, provided there is sufficient vertical and horizontal clearance for positioning the multi-stage pump, and also provided that the pumping media has a low solids content, as multi-stage pumps may typically be damaged by solids. For applications where there is not sufficient clearance for a multi-stage pump, a combination of submersible pumps and/or horizontal pumps may be utilized. At the lowermost level of the mine, a plurality of horizontal pumps may be connected in series, (also referred to as “daisy-chained” together), to gather the liquid collected at the bottom of the mine. In some applications, a plurality of submersible pumps, connected together in series at successive vertical levels of the mine, may be utilized to pump the liquid successively to different levels of the mine, thereby achieving the total required head. Other examples of applications for which many different pumps may be required, include different applications for sump pumps, such as at a mining site, different types of chemical and processing plants, and various oil and gas operations. In some cases, a cantilever pump may be practical and economical, whereby the motor is separated from the pump via an extended pump shaft, so that the pump motor does not meet submersible pump specifications. Centrifugal pumps of various types are also used extensively in manufacturing plants, including but not limited to fiberglass, pulp and paper, and steel manufacturing operations.

In the prior art, the applicant is aware of pumping systems, for example used in hydraulic fracturing operations in the oil and gas industry, wherein fracking fluid pumps may be connected together in series to boost the head to sufficient levels for fracturing underground geological structures. Such pumps may also be connected together in parallel, to increase the flow rate of the output of the pumping system.

The applicant is aware of U.S. Pat. No. 6,790,017 to Takura et al which discloses an integrated pump comprising a plurality of cell pumps, each cell pump having an inlet to draw pumping media from a consolidated inlet and an outlet to discharge fluid to a consolidated outlet. The integrated pump may thereby obtain a desired output by connecting in series or parallel a plurality of the cell pumps within the integrated pump. The integrated pump has a body or frame forming its consolidated inlet and outlet, and fixing plates to connect the inputs and outputs of each of the individual cell pumps to the consolidated inlet and outlet of the integrated pump.

In U.S. Pat. No. 8,123,458 to Racer et al there is disclosed a stacked pump arrangement for mixed-media flow that includes a first, self-priming, centrifugal pump with a volute having an inlet and an outlet, and a second straight centrifugal pump mounted to an upper portion of the first centrifugal pump. A transition chamber is connected, at one end, to the first centrifugal pump volute outlet and is connected, at the other end, to the second straight centrifugal pump volute inlet. The two centrifugal pumps are driven by either one or two external motors, the one or two motors connected to the shaft of each pump via a power transmission, such as a belt drive.

### SUMMARY

The present disclosure may be characterized, in one aspect, as a system of interconnecting modular pumps. In some embodiments, each individual pump may have a high internal pressure rating wherein a plurality of such pumps may be connected together in series; for example, by way of directly stacking one pump on top of the other so as to directly connect the outlet or discharge of a lower pump to the inlet or suction of the pump immediately above the lower pump. As another example, the plurality of pumps may be in a stacked, vertical and/or horizontal configuration wherein the inlets and outlets of the pumps are connected to each other through a plurality of fluid conduits. The plurality of pumps may also be in a stacked vertical and/or horizontal configuration, wherein the inlets and outlets of the pumps are connected to each other directly and/or through a fluid conduit. Furthermore, in one aspect the plurality of pumps may be connected together in any combination of horizontal and/or vertical orientations, and may be connected together in parallel and/or in series, providing a pumping system of any configuration using the plurality of individual, identical pumps.

The plurality of pumps may also be connected in series without stacking them in a vertical configuration; for example, by placing the pumps next to each other and then using fluid conduits to connect the outlet of one pump to the suction of an adjacent pump. In such configurations, the pumps positioned side-by-side may be oriented in the same direction, wherein the suction of each of the pumps is facing towards the ground, or in other configurations, some of the pumps may be oriented in a reverse direction whereby the suction of some pumps is facing towards the ground while the suction of other pumps is facing away from the ground, and/or the pumps may be positioned in a horizontal orientation. The plurality of pumps may additionally or optionally be connected in parallel, wherein the pumps may be connected together to a header or manifold through fluid conduits, to achieve, by various series/parallel combinations, the desired head and flow rate of the pumping system. The individual pump units may be substantially identical to one other to achieve the flexible interconnectivity of the plurality of pump units.

Advantageously, a user may stock a plurality of pumps, comprising one, two, three or more modular pump models, for a variety of applications. The flexibility of how the modular pumps may be connected to one another, either through a direct coupling or a flexible hose or other fluid conduit, combined with the advantages of weight and space savings realized by reducing the inventory of differently rated pumps required to be on hand, may provide increased efficiency and reduce the overall costs associated with having a large inventory of differently rated pumps. For example, a conventional pump inventory may include 20 to 30 differently rated pumps. Whereas, in the modular pumping systems described herein, an inventory containing only two, three or four different pump models, with a plurality of individual pumps of each pump model, may replace all of the 20 or 30 different pump types in a typical pump inventory, including but not limited to the horizontal, cantilever, multi-stage and submersible pumps of different ratings and wet end configurations that may be included in a conventional pump inventory. As well, a person skilled in the art will appreciate that the modular pumping system disclosed herein may be utilized in a wide variety of pumping applications.

In some embodiments, each pump of the plurality of interconnectable, modular pumps of a given pump model may have a same-sized, rectangular housing with a square cross section (cuboid), providing for the ease of interconnecting the modular pumps in different configurations, including configurations utilizing a plurality of pumps connected in series and/or in parallel with each other. Each pump may include a plurality of couplings for mechanically coupling two or more modular pump units via the pump housing of each modular pump unit. Advantageously, each modular pump unit includes a motor integrated inside the pump housing, the motor driving a shaft attached to the pump's impeller. Each modular pump includes a motor, and the motor only drives the shaft of that pump. This compact pump design facilitates the ease of stacking and connecting the pumps together in different configurations, and provides a pumping system that may have a smaller footprint compared to a conventional pumping system having two or more conventional pumps connected together in series and/or in parallel. Furthermore, because each modular pump has its own motor, if the pump or the pump's motor fails or requires service, that pump may be readily replaced with an identical pump so that the pumping system may continue operation while the replaced pump undergoes service or repair.

As well, by providing for example three modular pumps connected in series that are capable of replacing a single pump, it will be appreciated that in some cases where a smaller pump is required, the single, larger pump having a larger pump motor is oversized for the application requiring a smaller pump; whereas, the three modular pumps each including a motor may be readily used to both replace the larger pump in some applications, and a single pump of the three modular pumps may also be used for applications requiring a smaller pump. Thus, the use of an oversized pump in some applications because there is only a larger pump available in an inventory of pumps, may be resolved by replacing the larger pumps with a plurality of smaller, modular pumps, each modular pump having its own motor, and each modular pump designed to be connected together to provide different head and flow rates according to the required specifications for a given application.

Additional design considerations for the individual pump units include configuring the pump to handle a large solid size for the pump's respective wet end size; a concentric pump casing to provide for less deflection and wear on the pump shaft; and providing a variable speed motor for high efficiency of the pump, such as a variable-frequency drive motor. In some embodiments, a synchronous reluctance motor may be used to drive the pump shaft.

In some embodiments, the modular pumping system may provide for ease of maintenance, logistics, and storage, as each pump in the plurality of pumps is substantially identical to one another, featuring the same size and shape of housing and the same couplings and connectors and arrangement of such couplings and connectors, as well as the same motors, impellers and electronic controllers for interconnecting the suctions or discharges of the pumps to the suctions or discharges of other such pumps. In embodiments where the individual pump units have substantially identical rectangular or cuboid-shaped pump housings, the plurality of pump units may be efficiently stacked on top of one another and stored or positioned next to one another, to minimize the amount of space required for storing the pump units or for transporting the pump units to a different location. As well, the plurality of substantially identical, modular pump units have the same repair parts and require the same maintenance schedule, thereby reducing the complexity of maintaining and repairing the individual pump units of the modular pumping system. Advantageously, if one pump unit fails and requires repair, an identical pump unit may be installed in its place, thereby minimizing downtime of the pumping system while the one pump unit is undergoing repair.

In some embodiments, a wet hydraulic pump design may be optimized for variables as would be known to one skilled in the art. In another aspect of the present disclosure, the modular pumps, which may be submersible pumps, may have a dry running capability, such that the pumps may be used in non-submerged conditions, and may operate dry (ie: without pumping any pumping media) without overheating and failing, by incorporating a design that allows the pump unit motor to be sufficiently cooled under such dry run conditions.

In one aspect, a modular pump system for pumping a pumping media comprises a plurality of identical, releasably interconnecting pumps, each pump of the plurality of pumps comprising a housing having an inlet at a first end of the pump housing and an outlet at a second end of the pump housing, the second end opposite the first end, a suction at the inlet and a discharge at the outlet, an impeller downstream of the suction, the impeller mounted to a shaft, the shaft rotated by a motor, the motor, shaft and impeller enclosed within the housing. The discharge of a first pump of the plurality of pumps is releasably and directly interconnectable to the suction of an adjacent second pump of the plurality of pumps to directly and fluidly interconnect the discharge of the first pump to the suction of the second pump.

In some embodiments, the system includes a header having a discharge line, the header fluidly connectable to the discharge of each pump of at least two pumps of the plurality of pumps, wherein the at least two pumps of the plurality of pumps may be fluidly connected in parallel by releasably connecting the discharge of each pump of the at least two pumps to the header so as to fluidly interconnect the discharge of each pump of the at least two pumps to the header and the discharge line. In some embodiments, a fluid conduit is fluidly connectable to the discharge of the first pump with the suction of the second pump. In some embodiments, each pump of the plurality of pumps further comprises an inlet axis passing through and co-linear with an inlet flow path of the pumping media entering the pump through the suction and an outlet axis passing through and co-linear with a flow path of the pumping media exiting the discharge via a discharge conduit of the pump, wherein the inlet axis is spaced apart from and parallel to the outlet axis. In some embodiments, each pump of the plurality of pumps is configured to be stackable, and the discharge of the first pump directly interfaces with, so as to fluidly connect to, the suction of the second pump when the first end of the second pump housing is stacked on top of the second end of the first pump housing.

In another aspect, each pump of the plurality of pumps further comprises interlocking locators protruding from the first and second ends of each pump housing such that the locators are interlocked with one another when the second pump is stacked on top of the first pump. In some embodiment, the system comprises at least one accessory releasably attachable, to be adjacent to, the inlet or the outlet of a pump of the plurality of pumps. The accessory may be selected from a group comprising: a strainer plate attachable, to be adjacent to, an inlet of a bottommost pump of the plurality of pumps; a suction piece attachable, to be adjacent to, an inlet of an adjacent pump stacked on an outlet of the bottommost pump; an agitator attachable, to be adjacent to, an inlet of a bottommost pump of the plurality of pumps; a cantilever attachment attachable to, to be adjacent to, the outlet of a pump of the plurality of pumps.

In some embodiments, quick-release connectors may be provided on the housing of each modular pump to releasably attach the accessory to the first or second end of the housing of a pump of the plurality of pumps. In some embodiments, each pump of the plurality of pumps includes a discharge conduit positioned adjacent to a motor of the pump and in fluid communication with the discharge, wherein the pumping media flowing through the discharge conduit dissipates heat generated by the motor. In some embodiments, the housing of each pump of the plurality of pumps includes a plurality of cooling fins positioned adjacent to the motor of the pump so as to dissipate heat generated by the motor. In some embodiments, the pump casing surrounding the impeller of each pump of the plurality of pumps is a concentric pump casing. In some embodiments, the motor of each pump of the plurality of pumps is a variable-frequency drive motor. In some embodiments, the pump housing has a geometry chosen from the group comprising: cuboid, cubes. In some embodiments, a horizontal cross-section of the pump housing has a geometry that possesses horizontal and vertical planes of symmetry. In some embodiments, each pump of the plurality of pumps includes a plurality of fork lift slots in the pump housing for lifting, moving and installing each pump of the plurality of pumps.

### BRIEF DESCRIPTION OF THE DRAWINGS

FIGS. 1A to 1C are examples of performance curve charts for conventional series of submersible pumps.

FIG. 2 is a schematic diagram showing the interconnection of a plurality of pumps in parallel and in series, in an embodiment of the present disclosure.

FIG. 3A is a perspective view of an embodiment of the modular pump unit.

FIG. 3B is a top plan view of the modular pump unit of FIG. 3A.

FIG. 3C is a sectional view of the modular pump unit of FIG. 3A, taken along line A-A of FIG. 3B.

FIG. 3D is a sectional view of the modular pump unit of FIG. 3A, taken along line C-C of FIG. 3B.

FIG. 3E is a bottom plan view of the modular pump unit of FIG. 3A.

FIG. 4A is a sectional view of an embodiment of the modular pump units, taken along line A-A of FIG. 4C, the illustration of FIG. 4A showing two pump units connected to each other in series in a vertically stacked configuration.

FIG. 4B is a close-up view of the interface between the two modular pump units of FIG. 4A.

FIG. 4C is a top plan view of the modular pump units of FIG. 4A.

FIG. 4D is a perspective view of the vertically stacked modular pump units of FIG. 4A.

FIG. 4E is a further perspective view of the vertically stacked modular pump units of FIG. 3A.

FIG. 5A is a front plan view of an embodiment of the modular pump units, showing two pump units connected to each other in parallel in a side-by-side configuration.

FIG. 5B is a perspective view of the modular pump units of FIG. 5A.

FIG. 6A is a front plan view of an embodiment of the modular pump units, showing a pair of two pump units connected to each other in series in a vertically stacked configuration, with the pair of two pump units connected together in parallel in a side-by-side configuration to provide a pumping system using four modular pump units.

FIG. 6B is a perspective view of the pumping system of FIG. 6A.

FIG. 7A is a top plan view of a pumping system comprising three modular pump units connected together in series with a horizontal side suction and a vertical discharge.

FIG. 7B is a left plan view of the pumping system of FIG. 7A.

FIG. 7C is a front plan view of the pumping system of FIG. 7A.

FIG. 7D is a right plan view of the pumping system of FIG. 7A.

FIG. 8A is a left plan view of a modular pumping unit with a cantilever attachment.

FIG. 8B is a front plan view of the modular pumping unit of FIG. 8A.

FIG. 8C is a right plan view of the modular pumping unit of FIG. 8A.

FIG. 9A is a left plan view of a pumping system comprising two modular pumping units connected together in parallel with a cantilever attachment.

FIG. 9B is a front plan view of the pumping system of FIG. 9A.

FIG. 9C is a right plan view of the pumping system of FIG. 9A.

FIG. 10A is a top plan view of a pumping system comprising three modular pump units connected together in series.

FIG. 10B is a front plan view of the pumping system of FIG. 10A.

FIG. 10C is a right plan view of the pumping system of FIG. 10A.

FIG. 11 is a perspective view of a pumping system using an embodiment of three modular pump units connected together in series.

FIG. 12 is a performance curve chart for an illustrative example of two modular pump units in accordance with the present disclosure.

### DETAILED DESCRIPTION

Applicant is aware of a need for a modular pumping system, in which a plurality of modular pump units, comprising of only, for example and not intended to be limiting, in the range of three to six differently rated pumps, may be used to configure a variety of different pumping systems that provide the required head and flow rate. For example, a plurality of modular pump units, having ratings of 15 HP, 40 HP, 100 HP or 150 HP, and each pump in the inventory of pumps features the same flow rate and the same coupling components for directly, modularly coupling one pump to another pump in series, so as to increase the pumping head to a desired level. The pump units may also be coupled in parallel, for example to increase the flow rate of the pumping system or coupled together in a combination of series and parallel connections, as may be required to suit the needs of the application.

When a user desires to double the head of a 15 HP submersible pump, two such 15 HP pumps may be directly stacked, one on top of the other, so that the discharge of the first pump funnels or is otherwise directed into the adjacently positioned, abutting suction of the second pump. Alternatively, the pumps may be connected in series through a flexible hose or other fluid conduit. Similarly, when a user desires to double the flow rate of the pumping system, two pumps may be directly coupled in parallel, such that the discharge of each pump is connected together through one or several lengths of flexible hose or other fluid conduits such as a pipe and/or a manifold. In some embodiments, the use of flexible hose to connect the pumps together offers additional flexibility in configuring the pump; for example, in tight spaces within a site where vertically stacking the pumps, or using a multi-stage pump, may not be feasible. A user having an inventory of modularly interconnecting pumps may thereby build a pumping system having the desired head and flow rate in a directly integrated, stackable, pumping system comprising a plurality of the interconnectable pump units chosen from only a small range (such as three to six) of different horsepower-rated pumps. A further potential application for the modular pumping systems disclosed herein is to provide emergency replacement pumps for the majority of pumps or pumping systems on a site. In the prior art, it is generally the case that a particular pump configuration is selected for a given application, and when pump manufacturers may provide dozens or hundreds of pump configurations, it is often the case that a replacement pump is not readily available to replace a pump that has failed; instead, it may take weeks or months to obtain a replacement pump with the required specifications and configuration. However, with the proposed modular pumping system disclosed herein, a replacement pump or pumping system may be readily obtained by the end user or the manufacturer maintaining a plurality of the pump units and required accessories in their inventory.

In one aspect, it will be appreciated that a plurality of submersible, modular pump units may be connected together, with relative ease, in series and/or in parallel. Advantageously, because the pump housing, pump suction and pump discharge are each designed to interconnect with other pumps, either directly or through fluid conduits or other accessories, it is not necessary to provide an overall frame or other support structure that requires the modular pumps to be interconnected in a particular configuration, thus allowing the modular pumps to be connected together in a variety of different configurations.

In some embodiments, each pump may be relatively lightweight for manual lifting by two persons, and may be relatively simple to install or replace. The weight of each pump is preferably minimized, for example by using materials such as composites, plastics or aluminum in constructing the pump. A single pump should ideally fit on a standard dolly for ease of transportation, such as for example, a modular pump rated 15 HP. In one aspect, all pump units, including for example the 15 HP, 40 HP, 100 HP and 150 HP units, may include fork lift slots for moving and manipulating the pump units during installation and for moving and storing the pump units. The aforementioned range of pump ratings of the modular pumps is not intended to be limiting; as another illustrative example, a range of modular pumps may include pump units having 15 HP, 40 HP, 100 HP and 200 HP ratings, or any combination thereof.

In some embodiments, the impeller design for higher pressure pump units (for example, the 40 HP pump units) would preferably utilize low specific speed designs, whereas, larger HP models (for example, the 100 HP and 150 HP pump units) would utilize high specific speed designs. However, this is not intended to be limiting; in some embodiments, there may be provided a high specific speed version and a low specific speed version of a pump having the same motor size; for example, not intended to be limiting, there may be a high flow, low head 40 HP pump and a low flow, high head 40 HP pump. In a preferred embodiment of the two modular pump models having the same rating (40 HP) but different specific speeds (high specific speed and low specific speed), the outer profile of the pump housing at the inlet and outlet ends, and/or the design of the suction and the discharge, may have different designs so as to prevent connecting the high specific speed model of the 40 HP pump to the low specific speed model of the 40 HP pump. In other words, the two different models of the same size pump may include physical changes to the pump housing and/or the pump connectors so as to prevent connecting the two different versions of the 40 HP pump to one another. Other features of the pump may be altered so as to easily differentiate the high specific speed model from the low specific speed model, such as, colour coding and/or labelling on the pumps.

In an illustrative example of two different models of the same size of modular pump, not intended to be limiting, the Applicant's Model SQ-80 high head model may have a specific speed Ns of 600 US units, and the duty point/best efficiency point of the pump curve is equal to 180 GPM and 322 feet of head at 3450 RPM with a 40 HP motor. Whereas, the Applicant's Model SQ-80 high flow model may have a specific speed Ns of 887 US units, and the duty point/best efficiency point of the pump curve is equal to 550 GPM and 170 feet of head at 1780 RPM with a 40 HP motor. In a preferred embodiment, the pump housing and/or the pump connectors of the Model SQ-80 high head model and the Model SQ-80 high flow model are different, so as to prevent connecting the high head model and the high flow model to one another in series or parallel, as connecting the high head model to the high flow model may lead to operating issues and ultimately, failure of the pumps.

Drilled hole, dual sided straight radial vane, or traditional radial impeller designs may be used, depending on which is most efficient for a particular application. The pump unit may also be configured for high head, high pressure horizontal pumping systems. For larger sized pump units (for example, 100 HP and 150 HP designs) would have high head rise to shut off, high efficiency, concentric casing for reduced radial loading, and large solid size capability to provide greater flexibility for the different applications that such pump units could be used for. Additionally, the bearing design, seal design, and shaft design of each type of pump unit is configured to handle the different pumping system configurations for different applications.

In one example of a series of pump units, not intended to be limiting, higher pressure units may include the 40 HP pump units, which may advantageously have a lower specific speed impeller design, which may be suitable for pumping media having a high solids content. Whereas, the 15 HP, 100 HP and 150 HP units may be lower pressure units and a higher specific speed impeller design. It will be appreciated, however, that the above description of different configurations for the modular pump units are not intended to be limiting, and that other configurations are possible and intended to be included in the scope of the present disclosure. Generally speaking, useful characteristics of the pump units comprising the modular pumping systems described herein includes, but are not limited to, pump units that have both submersible and dry running capabilities, allowing the pump units to be used in vertical and horizontal applications; pump units which include impellers having low and high specific speed designs; and pump units having large solid size pumping capabilities.

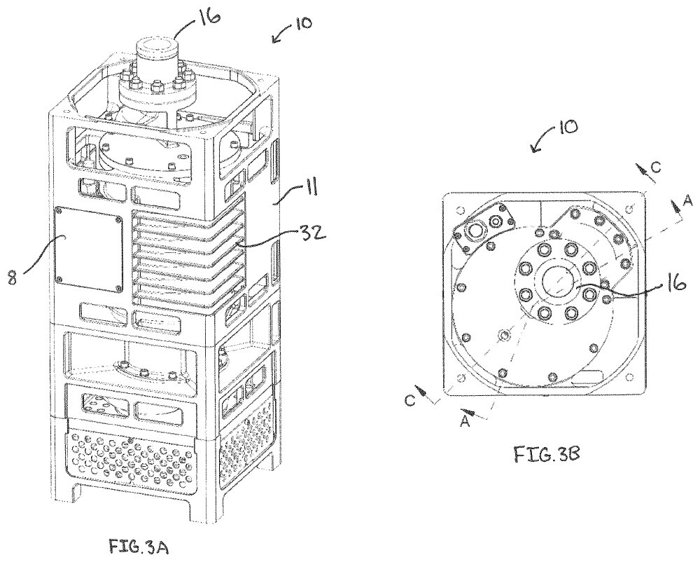

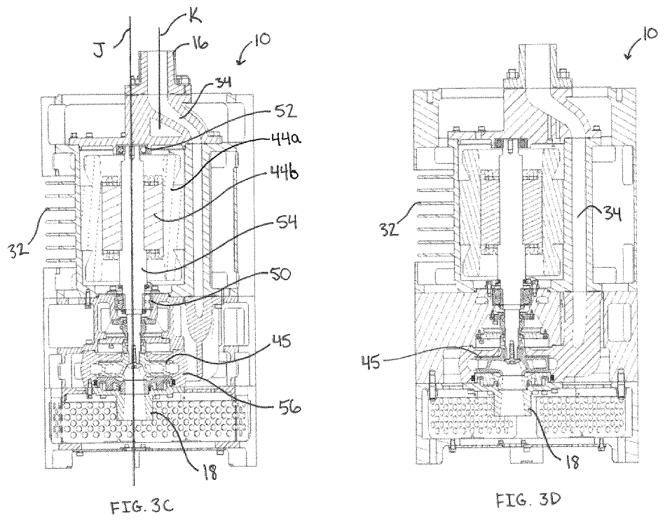

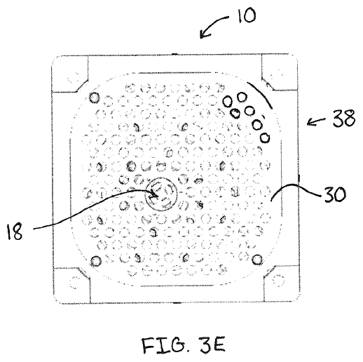

In some embodiments, the overall casing design may be rectangular with a square horizontal cross section, such as illustrated in the drawings; for example, see FIGS. 3A and 3B. Each pump is substantially identical, differing only for example in size and horsepower rating of, for example, 15 HP, 40 HP, 100 HP and/or 150 HP, and each having a single or dual stage impeller. However, it will be appreciated by a person skilled in the art that other geometries or configurations for the casing design are possible and included in the scope of the present disclosure, so long as they provide space and storage efficiency and are modularly interconnectable in a variety of series and parallel configurations. Other examples of horizontal cross-section geometries or shapes for the modular pumps disclosed herein may include, but are not limited to, circles, rectangles and hexagons. In one aspect, the horizontal cross-section geometry possesses both vertical and horizontal planes of symmetry. The compact design of the modular pump includes shifting the motor and the suction to one corner of the pump casing, and the discharge channel to the opposite corner of the pump casing, such that both the suction and the discharge of the pump are offset from the center of the horizontal cross section, as may be viewed for example in FIG. 3B (showing the discharge 16 offset from the center of the square cross-section of the pump housing), and FIG. 3E (showing the suction 18 offset from the center of the square cross-section of the pump housing, in an opposite corner of the square cross-section relative to the location of the discharge 16). This allows for the direct connection of the suction of one pump that is stacked on top of the discharge of a lower pump, by rotating the upper pump 180° relative to the orientation of the lower pump, so as to align the suction of the upper pump with the discharge of the lower pump. However, the other cross-section geometries of pump housing that are also symmetrical may be used in the construction of the modular pumps, allowing for a compact arrangement of the motor and the discharge channel within the pump housing and providing for the direct connection between the suction of one pump and the discharge of another pump. Thus, without intending to be limiting, the housings 11 may be cuboid as illustrated, or may be cubes or other space-efficient, three-dimensional geometries that are stackable and which may be placed adjacent to one another with a minimal footprint.

In some embodiments, a mechanical seal, preferably capable of withstanding pressures in the range of 700-900 psi, is used in the coupling components between adjacent pumps. The seal's pressure rating may be a limiting factor in how many modular pumps may be coupled in series. Pressure relief mechanisms may also be included to mitigate pump explosions and catastrophic pump failure under clogged discharge conditions, and to save the mechanical seal from failing under upset conditions.

Cavitation protection may also be provided, where the modular pumps are to be used in series. High pressure quick connects may provide the main coupling mechanism between the pumps with high pressure flexible slurry hose. Preferably, in some embodiments the pumps directly physically connect to one another in different orientations, providing for configuration flexibility in tight installation spaces. The pumps may be removed and added to one another using lever-style quick connects, for example; however, this is not intended to be limiting, and other mechanisms for coupling the modular pumps together may be utilized, depending on pressure requirements. Single to quad volute designs and/or diffusers may be employed for space saving and reduced radial loading. Higher-rated models may have a quad volute for minimal space constraints. Electrical cable entry into the casings may also be lever-style quick connects oriented for ease of replacement and for putting pumps in series. Cable may be sized according to maximum current for the maximum number of pumps to be connected in series. Alternatively, each pump may have its own cable, the system having a central portable control unit. In another aspect, the pumps may have lifting lugs and/or fork lift slots, in multiple locations on the pump housing, to allow for ease of maintenance, transportation, installation and logistics.

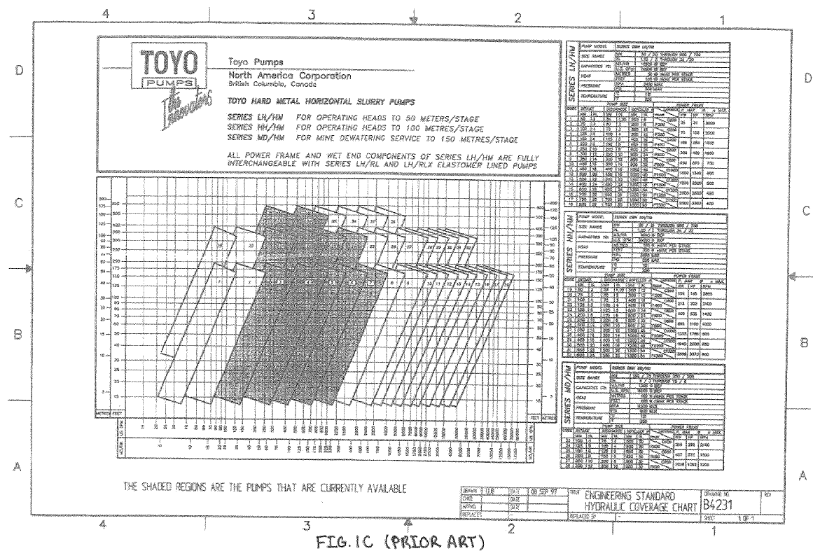

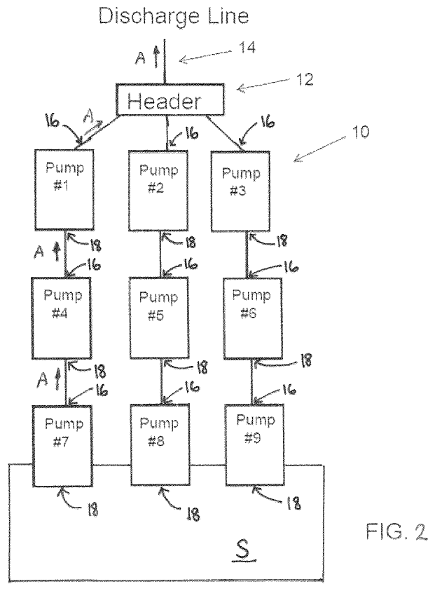

An illustrative example, shown in the schematic diagram of FIG. 2, includes nine separate modular pumps 10 are shown in a configuration combining the pumps 10 in both parallel and series for pumping fluid in direction A. Specifically, the discharge 16 of each of the pumps 10 numbered #1, #2 and #3 are fluidly connected in parallel to header 12, while a single discharge line 14 leads from header 12. Additionally, pump #1 is fluidly connected in series to pumps #4 and #7, whereby the suction 18 of pump #7 is submerged in a pumping media, such as a slurry S. The discharge 16 of pump #7 is fluidly connected to the suction 18 of pump #4. The discharge 16 of pump #4 is fluidly connected to the suction 18 of pump #1. As mentioned above, the discharge 16 of pump #1 is fluidly connected to the header 12 and discharge line 14. Similarly, pump #2 is fluidly connected in series to pumps #5 and #8, while pump #3 is fluidly connected in series to pumps #6 and #9. It will be appreciated by a person skilled in the art that the series connections between the pumps 10, as shown in FIG. 2, may be accomplished either by directly connecting the suction of one pump to the discharge of an adjacent pump, or by connecting the suction of one pump to the discharge of the adjacent pump by means of a flexible hose or other fluid conduit.

An embodiment of the single modular pump unit 10 is illustrated in FIGS. 3A-3E . The centrifugal modular pump unit 10 features an suction 18 and a discharge 16, the discharge 16 disposed on an opposite end of the suction 18. The motor 44, comprising the motor stator 44a and the motor rotor 44b, drives the shaft 54, the shaft 54 being short and robust and supported by upper and lower bearings 52, 50. The shaft 54 rotates the impeller 45. Advantageously, the motor 44 is positioned adjacent to the cooling fins 32 of the pump housing 11, which assists with cooling the motor 44 during operation, regardless of whether the pump 10 is submerged in the pumping media or is operating in the atmosphere. The compact design of the pump 10 also features the discharge channel 34 running adjacent and alongside the pump motor 44, which may further contribute to transferring heat away from the motor 44 when the pump is in operation. As best viewed in FIGS. 3C and 3D, the impeller 45 is enclosed in a concentric casing 56. The housing 11 additionally features an access panel 8, providing access to the electronic controller, sensors, and other electronic components of the pump 10 for repair and maintenance purposes.

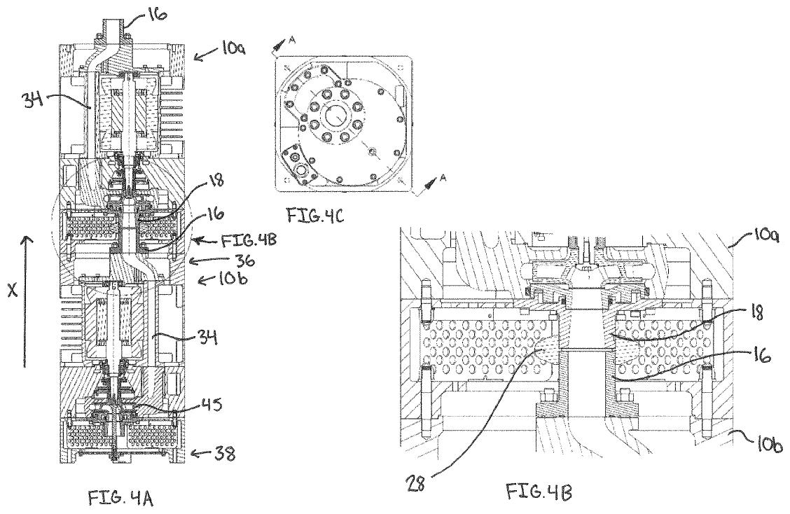

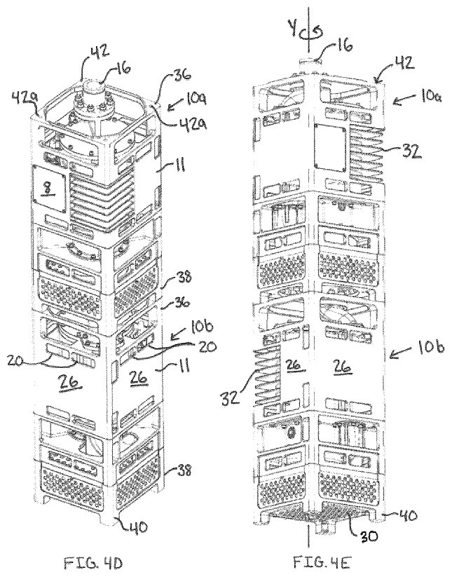

A series combination of two pumps 10 is illustrated in FIGS. 4A-4E . First and second pumps 10a, 10b are shown coupled in series to one another, in a vertically stacked configuration. First pump 10a is shown directly mounted in series to the second pump 10b, wherein the suction 18 of pump 10a is coupled directly to the discharge 16 of pump 10b. The pumps 10a and 10b are identical to each other. Thus, an outlet or second end 36 of each pump 10 includes a discharge 16, wherein the discharge 16 is positioned and configured to connect in fluid communication directly to the suction 18 at the inlet or first end 38 of another pump 10. (Herein, the phrase “inlet” is interchangeable with “first end” and the phrase “outlet” is interchangeable with “second end”). Thus in FIGS. 4A-4E , the discharge 16 on the outlet or second end 36 of pump 10b is mated with, to funnel the fluid discharged from pump 10b into, the suction 18 positioned at the inlet or first end 38 of pump 10a.

In some embodiments of the present disclosure, the direct coupling of two modular pumps in series may be accomplished by configuring each modular pump to have a suction at a first end 38 of the pump 10 and a discharge at a second end 36 of the pump 10, the second end 36 oppositely disposed from the first end 38 of the pump 10, whereby the flow path of a pumping media flowing through the pump 10 is substantially linear between the suction at the first end 38 and the discharge at the second end 36. For example, as best viewed in FIG. 4A, the discharge channel 34 of the bottom pump 10b in the stacked series configuration receives pumped media from the impeller 45 of pump 10b, and the pumped media flows upwardly in direction X through discharge channel 34 towards outlet 16 of pump 10b. The pumped media then flows directly into the suction 18 of the upper pump 10a and through the centrifugal impeller 45 into the discharge channel 34 of the second, upper pump 10a, still flowing in a generally upward direction (direction X) and through the discharge 16 of pump 10a. In such embodiments, the direct coupling between the suction 18 of a second pump and the discharge 16 of a first pump upstream from the second pump may be accomplished, for example, by vertically stacking the second pump on top of the first pump to directly interface or couple the suction 18 of the second pump and the discharge 16 of the first pump. An annular seal 28 may be positioned around, so as to seal the interface between, the discharge 16 of the first pump and the suction 18 of the second pump, as best viewed in FIG. 4B.

In another aspect, such as in the embodiment illustrated in FIGS. 4A-4E , a system of interlocking locators protruding from each of the first and second ends 38, 36 of each of the pumps 10a and 10b may be provided to assist with aligning the suction 18 of the first pump 10a with the discharge 16 of the second pump 10b, and also to provide some additional mechanical stability to the stack of pumps when pump 10a is stacked on top of pump 10b to couple suction 18 onto discharge 16. For example, without intending to be limiting, the casing 11 of each pump is preferably identical, and advantageously may be shaped substantially as a cuboid. Specifically, the cuboid geometry of casing 11 may, in some embodiments, include four rectangular sides 26, wherein each opposite end of the four rectangular sides terminates in a corresponding common plane, thereby forming a square cross-section laterally across the rectangular sides of the casing, the cross-section having constant dimensions along the casing.

The first and second ends 38, 36 of each pump 10 may include interlocking or mating alignment locators such as the illustrated locator feet 40 extending from first end 36 and complementary locator surface 42, having corresponding apertures 42a for optionally receiving a fastener to fasten the second end 36 of the lower pump 10b to the first end 38 of the upper pump 10a.

Therefore, for example, when stacking the first end of 38 of pump 10a onto the second end 36 of pump 10b, the locator surface 42 on the first end 38 of pump 10b mates with the locator feet 40, such that, once so stacked, the side walls of pump casing 11 of pump 10a are substantially flush, so as to be substantially co-planar with, the side walls of pump casing 11 of pump 10b, shown for example in FIGS. 4D and 4E.

It will be appreciated by a person skilled in the art that the embodiment of alignment locators illustrated and described herein is not intended to be limiting and is provided merely as one example of interlocking alignment locators. For example, complementary, interlocking or mating locator structures, such as are known or may be known to a person skilled in the art, may be utilized and are intended to be included in the scope of the present disclosure.

In another aspect of the present disclosure, the pump units 10a, 10b, which may be submersible pumps, may also have dry run capabilities, allowing the pump system to be used in a variety of different applications and operating conditions. For example, with reference to the embodiments illustrated in FIGS. 4A-4E , the motor 44 is positioned adjacent to the discharge channel 34 leading to the discharge 16. Additionally, the pump housing may be provided with cooling fins 32 positioned adjacent to the motor 44. Thus, if the pump unit 10a is running on dry land (rather than submerged in the pumping media), the pumping media flowing through the discharge channel 34, and/or the cooling fins 32, may cool the motor so as to avoid overheating the motor. Furthermore, should the pump unit 10a run dry (such that no pumping media is flowing through the pump), the pump impeller 45 acts as a fan, drawing cool air through the discharge channel 34 to cool the motor 44. In some embodiments, the motor 44 may be an electric motor which needs to be cooled under operating conditions; however, in other embodiments, the motor 44 may be a hydraulic motor, in which case cooling of the motor may not be required.

As shown in the embodiments illustrated herein, for example in FIGS. 4A to 4E, the casing 11 of each pump 10 is rectangular in side elevation, and square in horizontal cross-section. This is one example of how the casing 11 of the modular pumps 10 may be efficiently shaped and configured to minimize their footprint and provide for ease of configuration of the pumps, which may be particularly advantageous in applications where clearances are tight. Furthermore, the geometry of pump casing 11, which may for example be a rectangular prism, allows for efficient stacking of the pump units 10 side-by side and stacked on top of one another, which provides for storing a plurality of pump units within a smaller footprint of storage space, and for economical storage and transportation of the plurality of pump units 10.

As shown in FIG. 3C, an inlet axis J passing through the center of the suction 18 of the pumping unit 10 is spaced apart from, and parallel to, an outlet axis K passing through the center of the discharge 16 of pumping unit 10. Thus, the flow path through the modular pumping unit 10 is vertical, with the inlet axis J offset from the outlet axis K. As may be appreciated in FIGS. 4A to 4E, in the embodiment illustrated therein, each pump 10a, 10b is rotated about a vertical axis Y by 180 degrees relative to the immediately adjacent pump 10. For example, pump 10a is rotated 180 degrees about axis Y relative to pump 10b, so as to align the suction 18 of pump 10a with the discharge 16 of pump 10b.

In another aspect, at least some embodiments of modular pump 10 may be lifted and positioned by the manual strength of two workmen; for example, pumps 10 having a 15 HP power rating. Additionally, as viewed for example in FIG. 4D, lifting lugs or fork lift slots 20 may be formed in the sides of the pump casing 11.

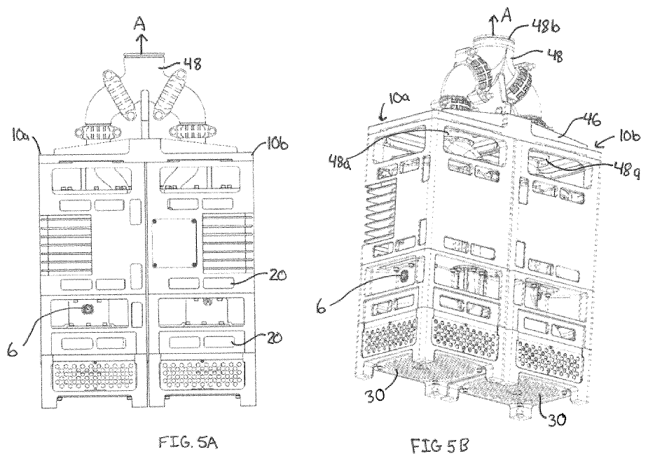

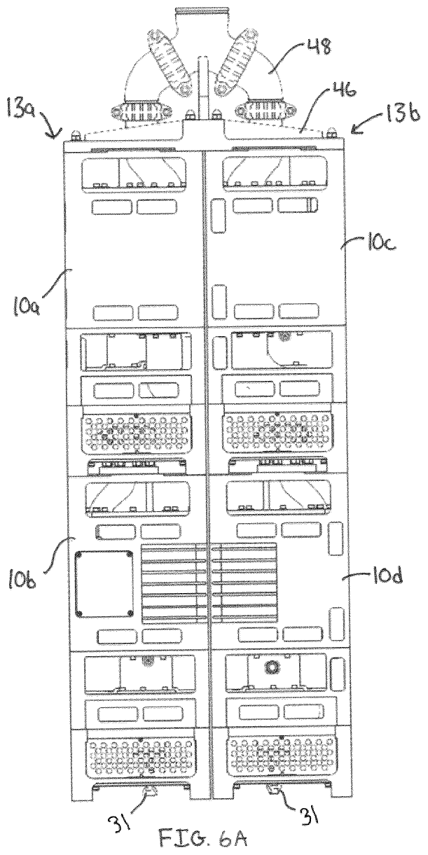

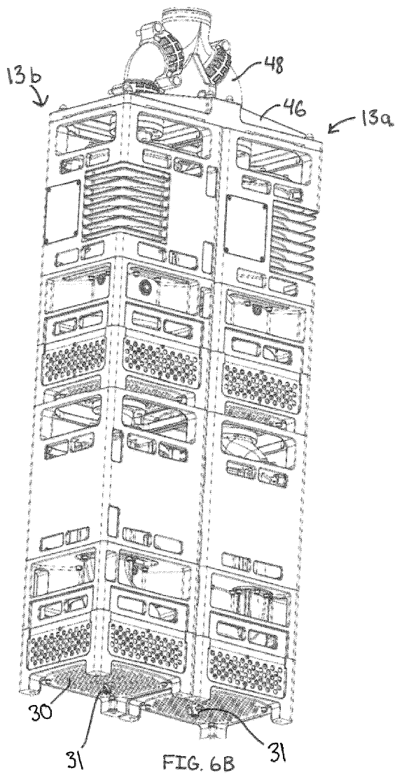

A removable strainer plate 30 of pump 10 such as viewed in FIG. 5B may be secured to the bottom of the pump 10 with bolts or other fasteners. For example, where pump 10 is the bottommost pump in fluid communication with the pumping media, such as a slurry S, the strainer plate 30, as also shown on bottommost pump 10b in FIG. 4E, is submerged in the pumping media, and the strainer plate prevents large debris from entering the suction of the bottommost pump in the vertically stacked arrangement. As best viewed in FIGS. 6A and 6B, some pump units may include an optional agitator 31, which extends through an aperture in the strainer plate 30 for agitation of the media to be pumped. However, where pump 10 is installed on top of another pump 10, for example pump 10a installed on top of, and connected in series to, pump 10b as illustrated in FIGS. 4A-4E , the removable strainer plate 30 may be substituted for a suction piece (not shown) for connection to the discharge of the pump 10 positioned immediately below. In another aspect of the present disclosure, there may be provided different versions of the suction piece, thereby providing increased flexibility for connecting a plurality of pumps 10 in series. For example, directly stacking pumps on top of one another may minimize the footprint required for the pumps when connected in series.

In another aspect, the agitator 31 of pump 10 may advantageously comprise a quick disconnect feature, allowing for different types of agitators 31 to be installed on pump 10 for different applications. The agitator's quick disconnect feature additionally provides the advantage of ease of maintenance, as the agitator may need to be replaced from time to time. A rubber cap (not shown) may be provided to protect the agitator threads and keep the sleeve in place, when an agitator is not attached to the pump.

As shown in FIGS. 5A and 5B, two or more modular pump units 10a, 10b may be connected in parallel, such that the discharge 16 of each unit feeds into a common conduit or header 48. The housings 11 of each pump unit 10a, 10b are positioned directly adjacent to, so as to contact, one another, and the housings may also be physically connected to each other by means of a coupling frame 46, which coupling frame 46 may be fastened to the housings 11 of each pump unit 10a, 10b. The common conduit or header 48 may include two or more inlets 48a, which are coupled to the respective discharge 16 of each pump unit, and the common conduit 48 may also include a single outlet 48b, through which the pumped media is discharged in direction A.

As illustrated in FIGS. 6A and 6B, a plurality of modular pump units 10 may be connected together both in series and in parallel, so as to configure a pumping system that meets the desired head and flow rate requirements. In this example configuration, pump units 10a and 10b are connected to each other in series, and pump units 10c and 10d are also connected to each other in series, each in a vertically stacked configuration. Additionally, the two vertical stacks, 13a and 13b, are connected to each other in parallel via a coupling frame 46 and a common conduit 48, with the coupling frame 46 fastened to each of the uppermost pumps 10a, 10c of the vertical stacks 13a, 13b respectively.

Additional examples of different configurations of the modular pumps described herein will now be described. It will be appreciated that the examples of pumping system configurations, described herein, are merely intended to be illustrative examples of possible configurations for the modular pumping system described herein, and are not intended to be limiting. It will be appreciated by a person skilled in the art that the modular pumps, described herein, may be configured in numerous ways, and all such configurations are intended to be included in the scope of the present disclosure.

FIGS. 7A to 7D illustrate a configuration of three modular pump units 10a, 10b, 10c which are connected in series to one another. Two of the pump units 10b, 10c are oriented in a horizontal configuration, with an elbow suction conduit 62 attached to the suction 18 of pump unit 10c, whereas the third pump unit 10a is oriented in a vertical orientation. The discharge 16 of pump unit 10c is attached to the suction 18 of pump unit 10b by a C-shaped conduit 64. And the discharge 16 of pump unit 10b is attached to the suction 18 of pump unit 10a via a conduit 66. The pumping system discharges the pumped media out of the discharge 16 of pump unit 10a. Each of the pump units 10a, 10b and 10c are supported on stands 68. Thus, the suction conduit 62 is oriented in a horizontal direction, and the discharge (discharge 16 of pump unit 10a) is oriented in a vertical direction, for a pumping system with three pumps connected in series.

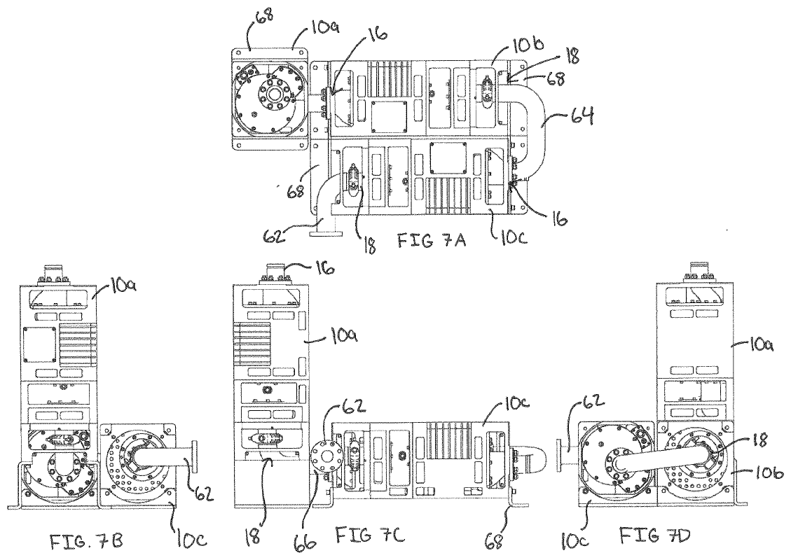

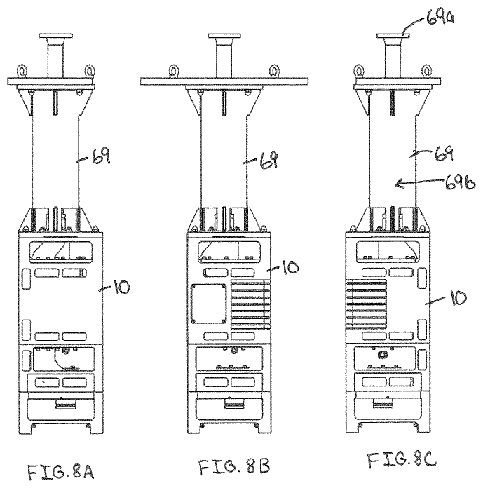

FIGS. 8A to 8C illustrate a cantilever attachment 69 attached to the discharge (not shown) of a pump unit 10. The cantilever attachment 69 comprises a hollow conduit 69b, a discharge 69a, and an optional platform 69c. Thus, one or more of the pump units 10 may be used to replace a cantilevered pump by attaching a cantilever attachment 69 to the discharge of a pump unit 10. Although a prior art cantilevered pump may typically be configured to distance an electric motor of a pump from the body of the pump, so that the pump may be submerged in the pumping media while maintaining the electric motor outside of the pumping media, such cantilevered pumps have the drawback of requiring a longer shaft passing through the cantilevered section of the pump. In contrast, the pump motor (not shown) remains inside the pump unit 10, and the cantilever attachment 69 allows for the spacing of the discharge 69a from the pump unit 10, the pump unit 10 typically being submerged in the pumping media. Advantageously, this allows one to configure the modular pumps 10 of the present disclosure to be a drop in replacement for specific pump types, such as an existing cantilevered pump, where the form factor of an existing cantilevered pump may include for example a platform similar to the platform 69c of the cantilever attachment 69.

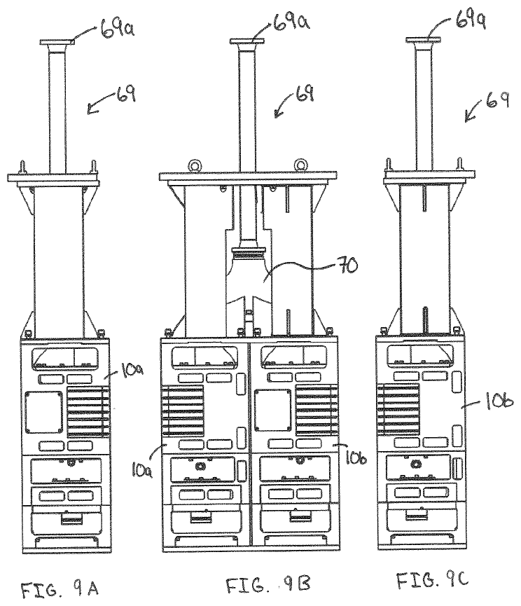

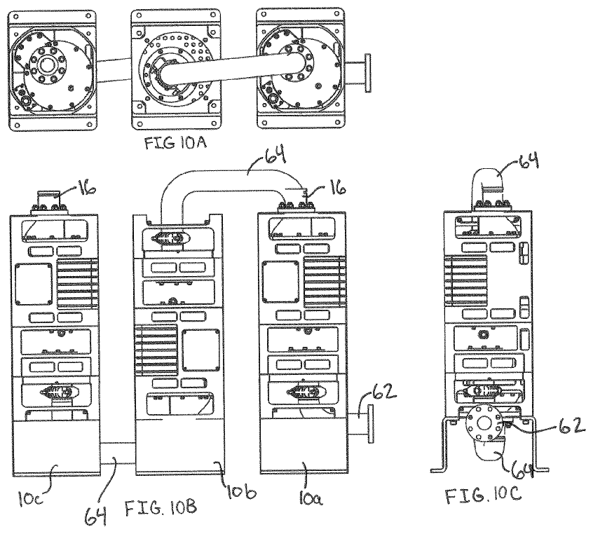

Similar to the configuration shown in FIGS. 8A to 8C, the configuration illustrated in FIGS. 9A to 9C also utilizes a cantilever attachment 69, but in this case, the cantilever attachment 69 includes a common header 70 for connecting two pumps 10a, 10b in parallel.

In FIGS. 10A to 10C, a pumping system is illustrated comprising three horizontally oriented pumps that are connected in series. As best viewed in FIG. 10B, the suction (not shown) of a first horizontally oriented pump 10a is attached to an elbow suction conduit 62. The discharge 16 of the first pump unit 10a is connected to the suction (not shown) of a second pump unit 10b through a C-shaped conduit 64. The discharge (not shown) of the second pump unit 10b is connected to the suction (not shown) of the third pump unit 10c through another C-shaped conduit 64. The pumping system discharges the pumped media through the discharge 16 of the third pump unit 10c. Advantageously, the example horizontal configuration shown in FIGS. 10A to 10C may replace a conventional set of horizontal pumps connected together in series, as may be commonly utilized for example in underground mines where space may be limited. The configuration shown in FIGS. 10A to 10C may be set up in a substantially smaller footprint, as compared to conventional horizontal pumps connected together in series.

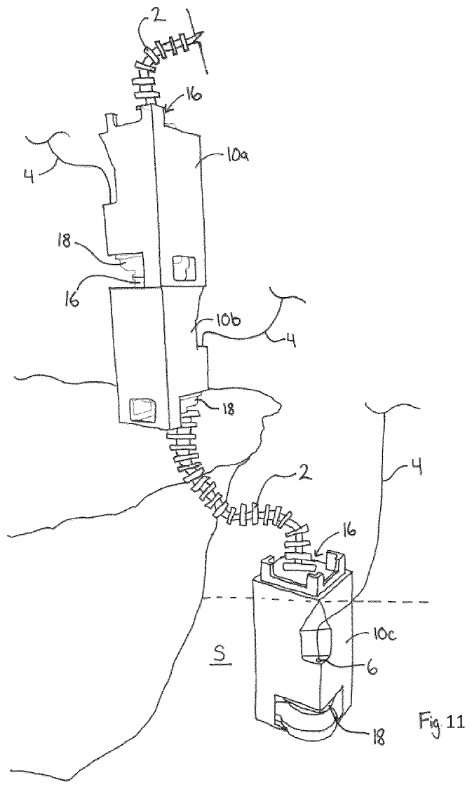

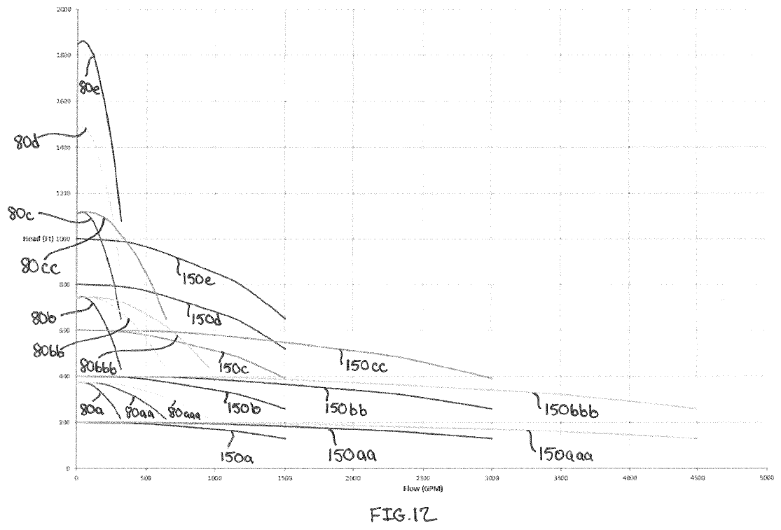

Still a further example of connecting multiple pumps 10 in series is illustrated in FIG. 11, illustrating several pumps 10 connected together in series to achieve the required head, in an application where there is insufficient clearance for stacking all of the pumps 10 directly on top of each other. As viewed in FIG. 11, a pump 10c is partially submerged in the pumping media S such that the suction of 10c is submerged in the pumping media (the surface of pumping media S shown in dotted line in FIG. 11). A length of flexible hose or other fluid conduit 2 connects the discharge 16 of pump 10c to the suction 18 of pump 10b, where pump 10b is positioned on a ledge above pump 10c. A third pump 10a is connected directly to pump 10b, whereby the discharge 16 of pump 10b is fluidly connected to the suction 18 of pump 10a. A further length of flexible hose or other fluid conduit 2 is connected to the discharge 16 of pump 10a so as to direct the discharged pumping media to, for example, a tank or sump for removal of the pumping media S. Additionally, power cables 4 are illustrated for each of the pumps 10a, 10b, 10c, exiting from the power cable port 6 on each pump 10 (the port 6 visible for example on pump 10c in FIG. 11). The opposite end of each power cable 4 is connected to a power source, such as an electrical outlet or a generator (not shown).

FIG. 12 provides a performance curve chart for an illustrative example of the coverage provided using only two models of the modular pumping units used in different configurations, in accordance with the present disclosure. The performance curve chart reflects the use of two exemplar modular pumping units: the SQ-80 model of pump having a 40 HP rating, and the SQ-150 model of pump having a 100 HP rating. Curves 80a to 80e indicate from one to five model SQ-80 pumps connected in series, with curve 80a representing one SQ-80 pump and curve 80e representing five SQ-80 pumps connected in series. Curves 150a to 150e indicate from one to five model SQ-150 pumps connected in series, with curve 150a representing one SQ-150 pump and curve 150e representing five SQ-150 pumps connected in series.

Continuing with FIG. 12, curve 80aa represents two SQ-80 pumps connected in parallel, and curve 80aaa represents three SQ-80 pumps connected in parallel. Similarly, curve 80bb represents two sets of two SQ-80 pumps connected in series, with the two sets of SQ-80 pumps also connected in parallel (for a total of four pumps in the pumping system), and curve 80bbb represents three sets of two SQ-80 pumps connected in series, with the three sets of SQ-80 pumps also connected in parallel (for a total of six pumps in the pumping system). Curve 80cc represents two sets of three SQ-80 pumps connected in series, with the two sets of SQ-80 pumps also connected in parallel (for a total of six pumps in the pumping system). Thus, curve 80bbb and curve 80cc each represent a pumping system comprising a total of six SQ-80 pumps, but connected together in different configurations.

Referring still to FIG. 12, curve 150aa represents two SQ-150 pumps connected in parallel, and curve 150aaa represents three SQ-150 pumps connected in parallel. Similarly, curve 150bb represents two sets of two SQ-150 pumps connected in series, with the two sets of SQ-150 pumps also connected in parallel (for a total of four pumps in the system), and curve 150bbb represents three sets of two SQ-150 pumps connected in series, with the three sets of SQ-150 pumps also connected in parallel (for a total of six pumps in the system). Curve 150cc represents two sets of three SQ-150 pumps connected in series, with the two sets of SQ-150 pumps also connected in parallel (for a total of six pumps in the pumping system). Thus, curve 150bbb and curve 150cc each represent a pump system comprising a total of six SQ-150 pumps, but connected together in different configurations.

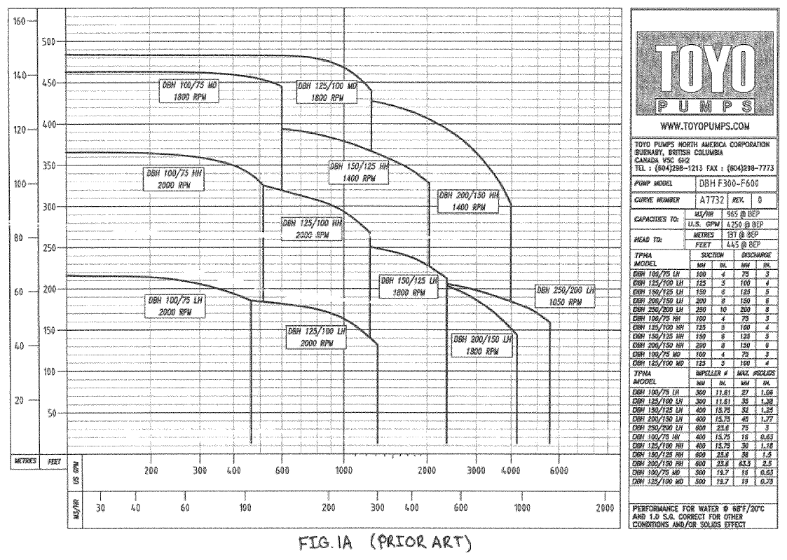

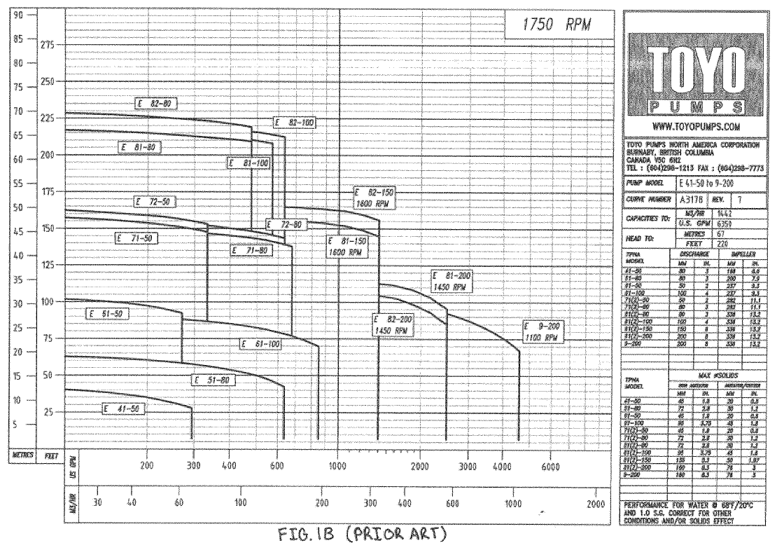

Thus, this illustrative example, not intended to be limiting, shows how to obtain head in the range of 200 feet to more than 1800 feet, and flow rates in the range of 0 to 4500 GPM, using different configurations of only two different models of modular pumps. This illustrative example may be compared to the prior art curve charts provided in FIGS. 1A to 1C, whereby each curve in each of FIGS. 1A to 1C represents a single model of pump, and to achieve different head and flow rates, it may be required to obtain several different models of pumps, thereby adding to the cost and complexity associated with purchasing, maintaining and repairing a large number of different models of pumps. It may also be appreciated that head and flow rates located in-between the curves shown in FIG. 12 may be obtained by varying the speeds of the motors included in the respective pumping systems represented by each curve in the chart.

As will be appreciated from the above examples of different configurations of the modular pumping units to provide different pumping systems, it is possible to configure pumping systems to meet head and flow rate specifications without having to stock a large number of differently rated pumps. It will be appreciated that the above example configurations are not intended to be limiting.

1. A modular pump system for pumping a pumping media, the system comprising:
a plurality of identical, releasably interconnecting pumps, each pump of the plurality of pumps comprising a housing having an inlet at a first end of the pump housing and an outlet at a second end of the pump housing, the second end opposite the first end, a suction at the inlet and a discharge at the outlet, an impeller downstream of the suction, the impeller mounted to a shaft, the shaft rotated by a motor, the motor, shaft and impeller enclosed within the housing,
wherein the housing includes a central axis passing through the housing from the first end to the second end of the pump,
wherein the discharge of a first pump of the plurality of pumps is releasably and directly interconnectable to the suction of an adjacent second pump of the plurality of pumps to directly and fluidly interconnect the discharge of the first pump to the suction of the second pump,
wherein at least one longitudinal axis passing through the housing from the first end to the second end of the pump is co-linear with at least one of the motor shaft, an inlet flow path, an outlet flow path, the suction and the discharge, and
wherein the at least one longitudinal axis is offset from the central axis of the housing.

2. The system of claim 1 further comprising a header having a discharge line, the header fluidly connectable to the discharge of each pump of at least two pumps of the plurality of pumps, wherein the at least two pumps of the plurality of pumps may be fluidly connected in parallel by releasably connecting the discharge of each pump of the at least two pumps to the header so as to fluidly interconnect the discharge of each pump of the at least two pumps to the header and the discharge line.

3. (canceled)

4. The system of claim 1 wherein the at least one longitudinal axis includes an inlet axis co-linear with the inlet flow path of the pumping media entering the pump through the suction and an outlet axis co-linear with the outlet flow path of the pumping media exiting the discharge via a discharge conduit of the pump.

5. The system of claim 4 wherein each pump of the plurality of pumps is configured to be stackable, and the discharge of the first pump directly interfaces with, so as to fluidly connect to, the suction of the second pump when the first end of the second pump housing is stacked on top of the second end of the first pump housing.

6. The system of claim 5 wherein each pump of the plurality of pumps further comprises interlocking locators protruding from the first and second ends of each pump housing such that the locators are interlocked with one another when the second pump is stacked on top of the first pump.

7. The system of claim 1 further comprising an accessory releasably attachable to, so as to be adjacent to, the inlet or the outlet of a pump of the plurality of pumps.

8. The system of claim 7 wherein the accessory is selected from a group comprising:
a strainer plate attachable to, so as to be adjacent to, an inlet of a bottommost pump of the plurality of pumps,
a suction piece attachable to, so as to be adjacent to, an inlet of an adjacent pump stacked on an outlet of the bottommost pump,
an agitator attachable to, so as to be adjacent to, an inlet of a bottommost pump of the plurality of pumps,
a cantilever attachment attachable to, so as to be adjacent to, the outlet of a pump of the plurality of pumps.

9. (canceled)

10. The system of claim 20 wherein each pump of the plurality of pumps includes a linear discharge channel positioned adjacent to the motor housing of the pump and in fluid communication with the discharge, wherein the pumping media flowing through the discharge channel dissipates heat generated by the motor.

11. The system of claim 10 wherein the housing of each pump of the plurality of pumps includes a plurality of cooling fins positioned adjacent to the motor housing of the pump opposite the discharge channel, wherein the cooling fins dissipate heat generated by the motor.

12. The system of claim 1 wherein the pump casing surrounding the impeller of each pump of the plurality of pumps is a concentric pump casing.

13. (canceled)

14. The system of claim 1 wherein the pump housing has a geometry chosen from the group comprising: cuboid, cubes.

15. The system of claim 1 wherein a horizontal cross-section of the pump housing has a geometrical shape that is symmetrical about central vertical and horizontal axes of the geometrical shape.

16. (canceled)

17. The system of claim 4 wherein the inlet axis is parallel to and spaced apart from the outlet axis.

18. The system of claim 1 wherein the at least one longitudinal axis is co-linear with the motor shaft.

19. The system of claim 18 wherein when the discharge of the first pump of the plurality of pumps is releasably and directly interconnected to the suction of the adjacent second pump of the plurality of pumps, the at least one longitudinal axis of the first pump and the first pump motor shaft is offset from the at least one longitudinal axis of the second pump and the second pump motor shaft.

20. The system of claim 18 wherein a motor housing of the motor is abutting an internal surface of the pump housing.

21. The system of claim 20 wherein a section of the pump housing further comprises a plurality of cooling fins, and wherein the motor housing of the motor is abutting the section of the pump housing comprising the plurality of cooling fins.

22. The system of claim 18 wherein each pump of the plurality of pumps includes a linear discharge channel positioned adjacent to a motor housing of the motor, wherein the discharge channel is configured to receive and pass through solids in the pumping media, the solids in the pumping media limited to a solids capacity of the impeller.

23. The system of claim 1 wherein the at least one longitudinal axis includes a suction axis co-linear with the suction of the pump.

24. The system of claim 23 wherein the suction axis is offset from the discharge axis.

25. The system of claim 1 wherein the at least one longitudinal axis includes a discharge axis co-linear with the discharge of the pump.

26. The system of claim 25 wherein the suction axis is offset from the discharge axis.
